(19) United States
(12) Patent Application Publication
(10) Pub. No.: US 2005/0249564 A1
(43) Pub. Date: Nov. 10, 2005

(54) Auxiliary handle for a portable power tool

(75) Inventors: Jonathan R. Van Bergen, Clemson, SC (US); Mark S. Huggins, Clemson, SC (US)

Correspondence Address: BRINKS HOFER GILSON & LIONE, P.O. BOX 10395, CHICAGO, IL, 60610, US

(73) Assignee: One World Technologies Limited, Hamilton (BM)

(21) Appl. No.: 10/839,042

(22) Filed: May 5, 2004

(51) Int. Cl. B23B 39/00

(52) U.S. Cl. 408/241 R

(57) ABSTRACT

A portable rotary power tool having an elongate auxiliary handle configured for securement to the power tool cooperates with the power tool primary handle to vary the reaction torque exertable upon the power tool by the user. The elongate auxiliary handle includes a fixed end attachable to the power tool motor housing and a free end extending outwardly generally away from the power tool output axis. A handle member provided adjacent to the free end to be grasped by a user includes a channel formed therein receiving a telescopic module. The telescopic module is adjustable relative to the handle member between a stored position received within the handle member and a plurality of telescopic positions.

### BACKGROUND OF THE INVENTION

1. Field of the Invention

This invention relates to an auxiliary handle configured for securement to a portable rotary power tool.

2. Background Art

Corded as well as cordless power tools, such as hand-held drills, are extensively used by electricians, plumbers, carpenters and others. Hand-held drills typically include a housing having a handle portion and trigger switch, a motor and spindle driven by the motor and a chuck holding a tool bit. Common tasks for such devices generally include drilling holes and driving fasteners such as screws. Such tasks may require additional leverage to complete the drilling or fastening operation.

Some power tool manufacturers have developed side mounted handles which provide the user leverage points on both the pistol grip and side handles. One problem with current handles is that the side mounted handles are not easily repositionable on the drill to accommodate a variety of drilling positions. Additionally, the handles cannot be positioned to allow easy storage in a tool case. Further, some side handles are limited in length by design limitations, which fail to provide sufficient leverage to a user during the drilling operation.

Another problem confronting an operator using the hand-held drill is the need to locate a particular drill bit or tool bit to accomplish a given task. Since the tool bits or drill bits are typically stored in a separate location from the power drill an operator might be required to leave his workplace to search for the specific drill bit or tool bit required to complete the job. This inevitably leads to time delays and associated increased labor costs to complete a particular project. To address this problem the prior art has provided devices which are either integrated into or attachable to the hand-held drills which hold drill bits and tool bits alike.

Therefore, there exists a need for a device for an auxiliary handle arrangement configured for securement to a portable power tool that is easily positionable on the power tool. A further need exists to provide an auxiliary handle arrangement which includes a telescopically mounted module which extends the operable length of the handle. Additionally, an auxiliary handle arrangement including a module for removably fixing and carrying drill bits, tool bits and fasteners which is readily accessible to an operator would also be advantageous.

### SUMMARY OF THE INVENTION

Accordingly, an auxiliary handle configured for securement to a portable rotary power tool includes a fixed end attachable to the motor housing and a free end extending outwardly generally away from the output axis of the power tool. A locking rotary attachment is provided on the fixed end of the auxiliary handle to connect the handle to the motor housing to accommodate various user handle orientation preferences relative to the power tool output axis.

A handle member is provided adjacent the free end of the auxiliary handle and includes a gripping surface to be grasped by a user. A channel is formed through the handle member and cooperates with an opening in the free end to receive a telescopic module. The telescopic module extends through the channel and opening in the free end of the handle and is adjustable relative to the handle member between a first position stored within the channel and one or more second extended positions.

In one aspect of the present invention, the telescopic module comprises an extension handle axially adjustable relative to the handle member to extend the length of the elongate auxiliary handle to vary the reaction torque exertable upon the power tool by the user. In another aspect of the present invention, the telescopic module further comprises a tool bit storage module adjustable relative to the handle member to store a plurality of bits to be used with the power tool. A locking member disposed on a first end of the telescopic module cooperates with at least one stop provided adjacent an opening in the free end of the handle to restrict the outward travel and secure the telescopic module in one of the one or more second extended positions.

### BRIEF DESCRIPTION OF THE DRAWINGS

FIG. 1 is a side plan view of a portable power tool having an auxiliary handle arrangement releasably secured thereto in accordance with the present invention;

FIG. 2 is a front plan view of the auxiliary handle arrangement in accordance with the present invention;

FIG. 3 is a cross-sectional view of a first embodiment of an auxiliary handle arrangement along line 3-3 of FIG. 2;

FIG. 4 is a cross-sectional view of the first embodiment of the auxiliary handle arrangement along line 3-3 of FIG. 2 with the extension handle in the extended position;

FIG. 5 is a cross-sectional view of a second embodiment of an auxiliary handle arrangement along line 3-3 of FIG. 2; and

FIG. 6 is a cross-sectional view of the second embodiment of the auxiliary handle arrangement along line 3-3 of FIG. 2 with the tool bit storage module in the extended position.

### DETAILED DESCRIPTION OF THE PREFERRED EMBODIMENT(S)

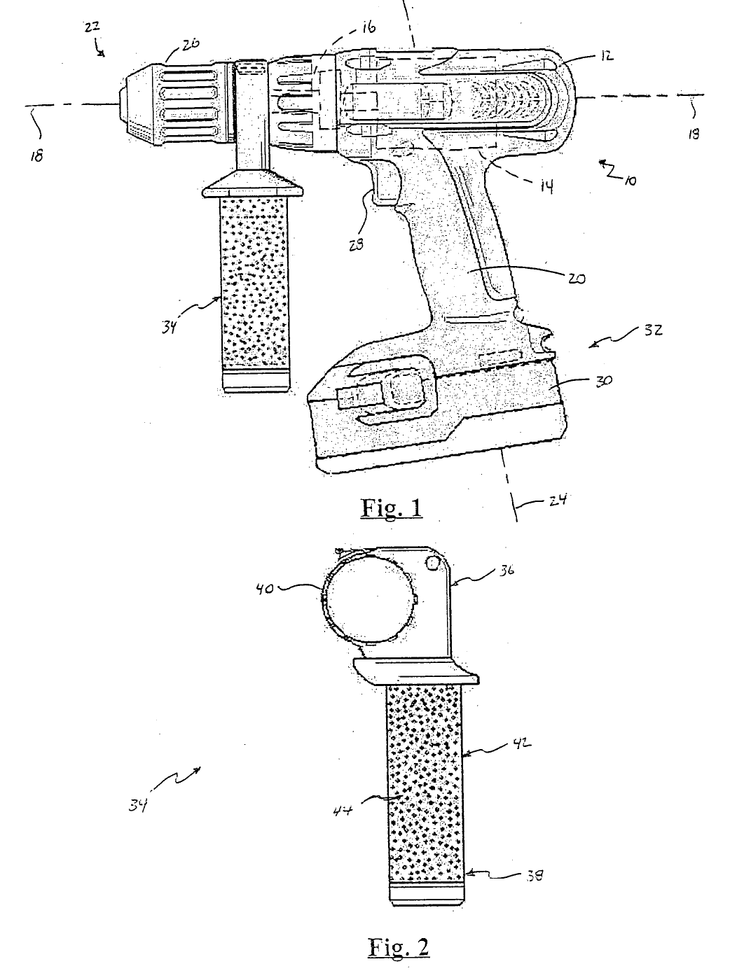

Referring now to FIG. 1, a portable rotary power tool such as a hand-held power drill 10 is shown. Power drill 10 has a housing 12 which accommodates a drive mechanism and motor 14 for driving a rotary output shaft 16. The drive mechanism, motor, and rotary output shaft are aligned along a tool axis 18. Housing 12 further includes a handle portion 20 for gripping the power tool 10, and directing a tool end 22 toward a workpiece. Handle portion 20 is aligned along a handle axis 24.

In operation a tool such as a tool bit, drill bit, or similar device is coupled to the rotary output shaft 16 for working on a workpiece. The tool is removably coupled to rotary output shaft 16 using a chuck 26, as conventionally known. Chuck 26 may be keyless or require a key (not shown) to open and close the chuck. Common tasks performed by the tool and hand-held power drill combination include, for example, forming holes and driving fasteners on and into the workpiece.

A motor activation switch 28 is disposed on the handle portion 20 for activating the drive mechanism and motor 14 to rotate the rotary output shaft. Preferably, a battery 30 is connected to the handle portion 20 at a power supply end 32 and provides electrical power to activate the drive mechanism and motor 14 for rotating the rotary output shaft 16. However, the present invention may be incorporated onto corded electric power drills (not shown) as well.

Referring additionally now to FIGS. 2-4, in accordance with the present invention, an elongate auxiliary handle 34 is releasably secured to motor housing or drill. Auxiliary handle includes a fixed end 36 attachable to the motor housing 12 and a free end 38 extending outwardly generally away from the output axis of the drill. Handle 34 shown in the Figures is generally cylindrical. However, it is understood that a variety of geometries may also be used to accomplish similar results.

A rotary locking attachment 40 provided on the fixed end 36 of handle 34 connects the handle 34 to a portion of the motor housing. Locking attachment 40 allows a user to circumferentially orient the auxiliary handle 34 at a variety of positions relative to the output axis 18 in order to accommodate various user handle orientation preferences. Additionally, locking attachment 40 enables a user to orient the elongate auxiliary handle 34 in a coplanar relationship with drill handle portion 20 when drill 10 is stored away as shown in FIG. 1.

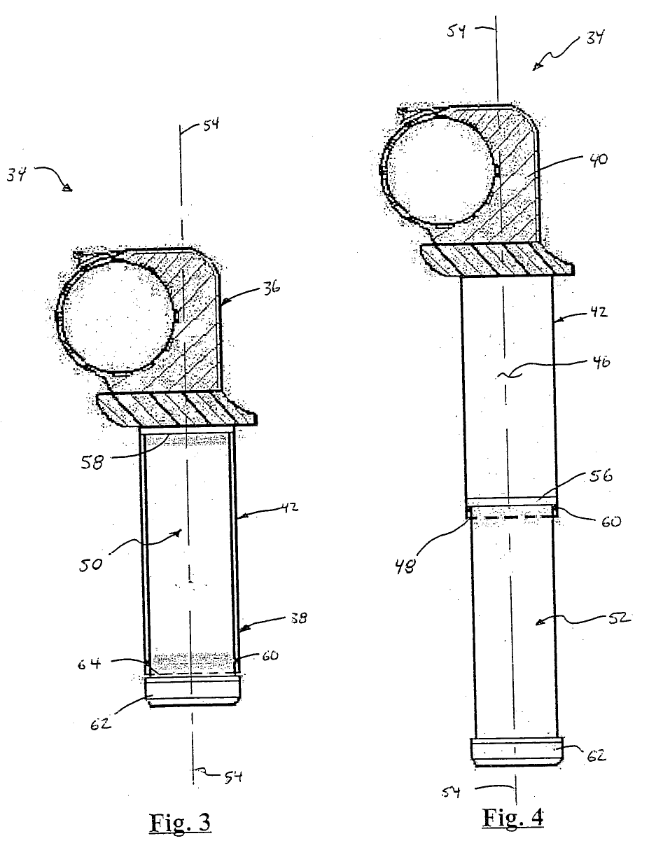

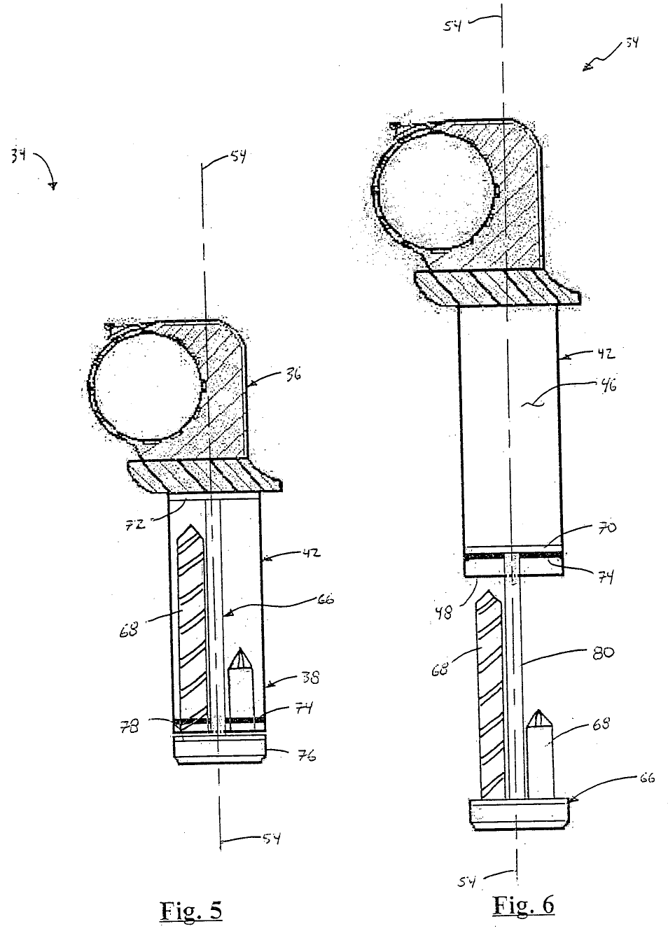

A handle member 42 is provided on the free end 38 of auxiliary handle 34. Handle member 42 includes a gripping surface 44 to be grasped by a user. A channel 46 formed through the handle member 42 cooperates with an opening 48 in the free end 38 of auxiliary handle 34 to receive a telescopically adjustable module 50. Telescopic module 50 extends through channel 46 and opening 48 in the free end 38 of handle and 34 and is adjustable relative to the handle member 42 between a first or stored position illustrated in FIGS. 3 and 5 and at least one second extended position shown in FIGS. 4 and 6. A description of the positioning of module 50 will be provided in greater detail below.

Referring now to FIGS. 3 and 4, a first aspect of the elongate auxiliary handle 34 of the present invention is disclosed. Telescopic module comprises an extension handle 52 axially adjustable within channel 46 relative to the handle member 42. Extension handle 52 is telescopically adjusted along handle axis 54 to extend the length of the elongate auxiliary handle 34 to vary the reaction torque exertable upon the power tool by the user.

A locking member 56 disposed on a first end 58 of handle 52 cooperates with at least one stop 60 provided in channel 46 adjacent opening 48 in free end 38 to restrict the outward travel of extension handle 52 relative to auxiliary handle 34. Locking member 56 and stop 60 cooperate to secure handle 52 in one or more extended positions. A variety of locking arrangements may be used to position module 50 relative to handle 34.

As is shown in FIGS. 3 and 4, locking member 56 comprises a circular plastic rim extending from the first end 58 of extension handle 52. In the stored position illustrated in FIG. 3, locking member 54 is positioned in channel 46 adjacent the fixed end 36 of auxiliary handle 34, such that the lower cap 62 extending from a second end 64 of handle 52 is positioned adjacent opening 48. In the extended position shown in FIG. 4, the extension handle 52 is telescopically extended away from the free end 38 of handle 34. A pair of detents 60 provided on opposing surfaces of channel 46 engage locking member 56, thereby limiting the maximum length of travel of extension handle 52. It is understood that multiple stops may be provided in the channel to allow a user to position the extension handle at a variety of positions relative to the auxiliary handle.

Referring now to FIGS. 5 and 6, a second aspect of the elongate auxiliary handle 34 of the present invention is disclosed. Reference numbers are used for similar features shown in FIGS. 1-4. Telescopic module comprises a tool bit storage module 66 axially adjustable within channel 46 relative to the handle member 42. Tool bit storage module 66 is telescopically adjusted along handle axis 54 and stores a plurality of drill and fastener bits 68 to be used with the power tool.

Locking member 70 comprises a rubber gasket from the first end 72 of storage module 66. In the stored position illustrated in FIG. 5, locking member 70 is positioned in channel 46 adjacent the fixed end 36 of auxiliary handle 34, such that the lower cap 74 disposed on a lower end 76 of storage module 66 is positioned adjacent opening 48. In the extended position shown in FIG. 6, storage module 66 telescopically extends away from the free end 38 of handle 34, allowing a user to access storage bits 68 mounted thereon.

At least one stop 78 comprises a retention ring formed about the periphery of channel 46 adjacent opening 48. Stop 78 engages locking member 70, limiting the maximum length of travel of storage module 66 relative to auxiliary handle 34. Retention ring 78 may also be formed as part of the handle housing, wherein opening 48 is reduced in size to restrict locking member 70 from extending past opening 48. It is understood that either the plastic rim and opposing detents locking member/stop arrangement illustrated in FIGS. 3 and 4 or the rubber gasket and retention ring arrangement illustrated in FIGS. 5 and 6 may be used with either aspect of the present invention.

Tool bit storage module 66 includes a center support member 80 which spans between locking member 70 and lower cap 76. Center support member 80 cooperates to support and retain tool bits 68 stored on module. In the embodiment shown in FIGS. 5 and 6, center support member includes one or more magnets which engage and retain bits 68 containing ferrous-based materials. Alternatively, center support member 80 may include one or more receiving arms to engage and retain the bits 68 within module 66.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A portable rotary power tool comprising:
a motor housing having a primary handle;
a motor and rotary drive mechanism located within the motor housing and providing a rotary output member aligned along an output axis; and
an elongate auxiliary handle configured for securement to the power tool having a fixed end attachable to the motor housing and a free end extending outwardly generally away from the output axis including an opening therethrough,
wherein the auxiliary handle includes a handle member provided adjacent to the free end to be grasped by a user, a channel formed within the handle member and a telescopic module extending through the channel and opening in the free end axially adjustable relative to the handle member between a first position stored within the channel and one or more second extended positions.

2. The power tool of claim 1 further comprising a locking rotary attachment connecting the elongate auxiliary handle fixed end to the motor housing so that the orientation of the elongate auxiliary handle can be circumferentially varied relative to the output axis in order to accommodate various user handle orientation preferences and to enable the elongate auxiliary handle to be oriented generally co-planar with the primary handle when the tool is stored.

3. The power tool of claim 1 further comprising a lock member for retaining the telescopic module securely in one of the one or more second extended positions.

4. The power tool of claim 3 further comprising at least one stop formed in the channel of the elongate auxiliary handle adjacent an opening in the handle cooperating with the lock member to restrict the outward travel of the telescopic module.

5. The power tool of claim 4 wherein at least one stop comprises a pair of detents formed on opposing surfaces of the channel.

6. The power tool of claim 1 wherein at least one stop comprises a retention ring formed around an inner periphery of the channel.

7. The power tool of claim 1 wherein the telescopic module further comprises a handle axially adjustable relative to the handle member to extend the length of the elongate auxiliary handle to vary the reaction torque exertable upon the power tool by the user.

8. The power tool of claim 1 the telescopic module further comprises a tool bit storage module adjustable relative to the handle member to store a plurality of bits to be used with the power tool.

9. An elongate auxiliary handle configured for securement to a portable power tool comprising:
a fixed end attachable to the power tool and a free end extending outwardly generally away from the power tool including an opening therethrough;
a handle member provided adjacent to the free end to be grasped by a user;
a channel formed within the handle member; and
a telescopic module extending through the channel and opening in the free end of the handle adjustable relative to the handle member between a first position stored within the channel and one or more second extended positions.

10. The elongate auxiliary handle of claim 9 further comprising a locking rotary attachment connecting the elongate auxiliary handle fixed end to the power tool so that the orientation of the elongate auxiliary handle can be circumferentially varied relative to the output axis in order to accommodate various user handle orientation preferences.

11. The elongate auxiliary handle of claim 9 further comprising a lock member disposed on a first end of the telescopic module and at least one stop provided adjacent an opening in the free end of the handle to restrict the outward travel and secure the telescopic module in one of the one or more second extended positions.

12. The elongate auxiliary handle of claim 11 wherein the at least one stop comprises a pair of projections formed on opposing surfaces of the channel.

13. The elongate auxiliary handle of claim 11 wherein the at least one stop comprises a retention ring formed around the periphery of the channel.

14. The elongate auxiliary handle of claim 9 wherein the telescopic module further comprises a handle axially adjustable relative to the handle member to extend the length of the elongate auxiliary handle to vary the reaction torque exertable upon the power tool by the user.

15. The elongate auxiliary handle of claim 9 wherein the telescopic module further comprises a tool bit storage module adjustable relative to the handle member to store a plurality of bits to be used with the power tool.

16. An elongate auxiliary handle configured for securement to a portable power tool comprising:
a fixed end attachable to the power tool and a free end extending outwardly generally away from the power tool including an opening therethrough;
a handle member provided adjacent to the free end to be grasped by a user;
a channel formed within the handle member; and
a telescopic handle extending through the channel and opening in the free end adjustable relative to the handle member between a first position stored within the channel and one or more second extended positions to extend the length of the elongate auxiliary handle to vary the reaction torque exertable upon the power tool by the user.

17. The elongate auxiliary handle of claim 16 further comprising a lock member disposed on a first end of telescopic the handle and at least one stop provided adjacent an opening in the free end of the handle to restrict the outward travel and secure the telescopic handle in one or more of the second extended positions.

18. An elongate auxiliary handle configured for securement to a portable power tool comprising:
a fixed end attachable to the power tool and a free end extending outwardly generally away from the power tool including an opening therethrough;
a handle member provided adjacent to the free end to be grasped by a user;
a channel formed within the handle member; and
a tool bit storage module extending through the channel and opening in the free end adjustable relative to the handle member between a first position stored within the channel and one or more second extended positions to receive and store a plurality of bits to be used with the power tool.

19. The elongate auxiliary handle of claim 18 further comprising a lock member disposed on a first end of tool bit storage module and at least one stop provided adjacent an opening in the free end of the handle to restrict the outward travel and secure the telescopic handle in one or more of the second extended positions.

20. The elongate auxiliary handle of claim 18 wherein the tool bit storage module includes a magnetic center support member extending between the lock member and a cap disposed on a second end of the module to support and retain tool bits stored on the module.
